(19) United States
(12) Patent Application Publication
(10) Pub. No.: US 2011/0026179 A1
(43) Pub. Date: Feb. 3, 2011

(54) Protection Device

(75) Inventor: Norbert Kasper, Detmold (DE)

Correspondence Address: LAUBSCHER & LAUBSCHER, P.C., 1160 SPA ROAD, SUITE 2B, ANNAPOLIS, MD, 21403, US

(73) Assignee: WEIDMUELLER INTERFACE GMBH & CO. KG, Detmold (DE)

(21) Appl. No.: 12/935,001

(22) PCT Filed: Mar. 26, 2009
(86) PCT No.: PCT/EP09/53623

§ 371 Date: Oct. 12, 2010

(30) Foreign Application Priority Data
Mar. 31, 2008 (DE) 102008016589.1

(51) Int. Cl. H02H 9/04

(52) U.S. Cl. 361/91.5

(57) ABSTRACT

An overvoltage protection circuit is provided for protecting a load against overload damage, including a coarse protection device for dissipating the major portion of the energy of the trouble event, a plurality of fine protection devices for limiting the remaining portion of the trouble energy to a safe value, a diagnostic arrangement for determining the operating condition of the destructible fine protection devices, and a disconnect arrangement for disconnecting from the protection circuit at least one of the fine protection devices that has been determined to be faulty. A trouble event identifying arrangement compares with a reference voltage standard a measured voltage existing at a measuring junction between the fine protection devices, and generates a fault signal in the event of destruction of a fine protection device. A display arrangement indicates whether or not a fine protection device has been determined to be faulty.

### REFERENCE TO RELATED APPLICATIONS

This application is a continuation of the International Application No. WO 2009/121799 based on PCT Application No. PCT/EP2009/053623 filed Mar. 26, 2009, which claims priority of the German Application No. 10 2008 016 589.1 filed Mar. 31, 2008. It is related to the inventor's companion U.S. application Ser. No. ______ filed ______ [Attorney's Docket No. 50039].

### BACKGROUND OF THE INVENTION

1. Field of the Invention

An overvoltage protection circuit is provided for protecting a load against overload damage, including a coarse protection device for dissipating the major portion of the energy of the trouble event, a plurality of fine protection devices for limiting the remaining portion of the trouble energy to a safe value, a diagnostic arrangement for determining the operating condition of the destructible fine protection devices, and a disconnect arrangement for disconnecting from the protection circuit at least one of the fine protection devices that has been determined to be faulty.

2. Description of Related Art

The protective device in question protects an electrical system against impairment and/or destruction by a disruptive event.

Within the context of the present disclosure, a disruptive event is understood as an event during which electrical energy is applied to an electrical system, specifically in such a way that the proper functioning of the electrical system is impaired or destroyed. Examples of disruptive events include lightning discharges or static discharges, which result in overvoltage pulses and/or overcurrent pulses being galvanically, inductively, or capacitively coupled into the electrical system, for example, thereby impairing or destroying the functioning of said system.

The structure and functioning of the above-specified protective system for electrical systems are known to a person skilled in the art, and therefore require no further explanation within the scope of the present invention.

The disadvantage of known protective devices of this type, however, is that they require a relatively high level of expenditure in terms of inspection, maintenance and, if necessary, replacement.

According to the invention, a protective element of the protective device that has been destroyed by a disruptive event is deactivated, so that further impairment of the electrical system being protected cannot occur through this destroyed protective element, and said system can continue to operate, at least temporarily, without intervention by technicians.

Expenditure on inspection, maintenance and any replacement that may be necessary is thereby advantageously decreased.

In a further preferred embodiment of the invention, after the protective element that is destroyed by a disruptive event has been deactivated, a backup protective element that will back up the function of the first protective element is activated, so that when the protective element is destroyed by a disruptive event, the full functioning of the protective device continues to be ensured. Expenditure on inspection, maintenance and any replacement that may be necessary is thereby advantageously further decreased, since the number of disruptive events that can occur before technicians must perform an inspection, maintenance or, if necessary, replacement is increased.

According to the invention, a protective element of the protective device that has been destroyed by a disruptive event is deactivated, so that further impairment of the electrical system being protected cannot occur through this destroyed protective element, and said system can continue to operate, at least temporarily, without intervention by technicians.

Expenditure on inspection, maintenance and any replacement that may be necessary is thereby advantageously decreased.

In a further preferred embodiment of the invention, after the protective element that is destroyed by a disruptive event has been deactivated, a backup protective element that will back up the function of the first protective element is activated, so that when the protective element is destroyed by a disruptive event, the full functioning of the protective device continues to be ensured. Expenditure on inspection, maintenance and any replacement that may be necessary is thereby advantageously further decreased, since the number of disruptive events that can occur before technicians must perform an inspection, maintenance or, if necessary, replacement is increased.

Accordingly, the present invention was developed to provide a protective device which will eliminate the described disadvantages.

### SUMMARY OF THE INVENTION

Accordingly, a primary object of the present invention is to provide an overvoltage protection circuit for protecting a load against overload damage, including a coarse protection device for dissipating the major portion of the energy of the trouble event, a plurality of fine protection devices for limiting the remaining portion of the trouble energy to a safe value, a diagnostic arrangement for determining the operating condition of the destructible fine protection devices, and a disconnect arrangement for disconnecting from the protection circuit at least one of the fine protection devices that has been determined to be faulty.

According to a more specific object, the protection circuit arrangement includes a trouble event identifying arrangement for comparing with a reference voltage standard a measured voltage existing at a measuring junction defined between the fine protection devices, and for generating a fault signal in the event of destruction of a fine protection device. A display arrangement indicates whether or not a fine protection device has been determined to be faulty.

According to another object of the invention, a protective element of the protective circuit device that has been destroyed by a disruptive event is deactivated, so that further impairment of the electrical system being protected cannot occur through this destroyed protective element, and said system can continue to operate, at least temporarily, without intervention by technicians.

Expenditure on inspection, maintenance and any replacement that may be necessary is thereby advantageously decreased.

In a further preferred embodiment of the invention, after the protective element that is destroyed by a disruptive event has been deactivated, a backup protective element that will back up the function of the first protective element is activated, so that when the protective element is destroyed by a disruptive event, the full functioning of the protective device continues to be ensured. Expenditure on inspection, maintenance and any replacement that may be necessary is thereby advantageously further decreased, since the number of disruptive events that can occur before technicians must perform an inspection, maintenance or, if necessary, replacement is increased.

### BRIEF DESCRIPTION OF THE DRAWINGS

Other objects and advantages of the invention will become apparent from a study of the following specification, when viewed in the light of the accompanying drawing, in which:

FIG. 1 is a circuit diagram illustrating the protection circuit of the present invention for protecting and electrical distribution system from disruptive events; and

FIG. 2 is a circuit diagram illustrating a modification of the protection circuit of FIG. 1.

### DETAILED DESCRIPTION OF THE INVENTION

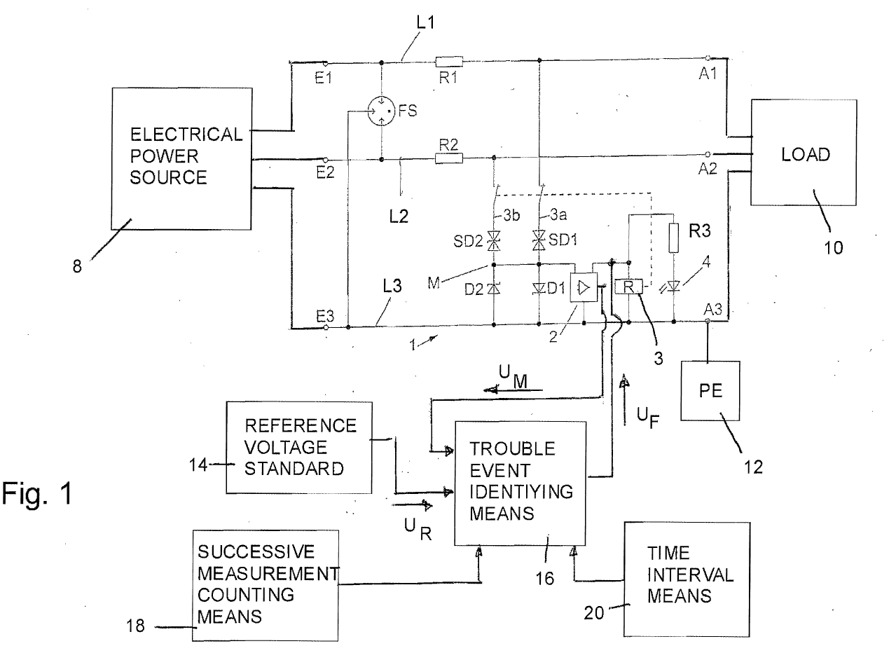

Referring first more particularly to FIG. 1, the protection circuit 1, which may be in the form of a module, includes three lines L1, L2, L3 having input terminals E1, E2, E3, respectively, connected with a voltage source 8 (for example, an electric power main, depending upon the intended use), and output terminals A1, A2, A3, respectively, connected with the load 10 (for example, an amplifier or an industrial printed circuit board). Lines L1 and L2 contain series connected resistors R1 and R2, respectively. In order to absorb the majority of the electrical energy generated by the trouble event, a gas-filled housing FS is provided having means connected to define a first spark gap between the third and first lines L3 and L1, and a second spark gap between the third and second lines L3 and L2. This part of the protective device is referred to as the coarse protection and “wipes out” the majority of the energy that is coupled into the protective device 1 as a result of a disruptive event.

The remainder of the protective device 1 is referred to as the fine protection and serves primarily to limit the occurring voltages to a level that poses no risk to the electrical system being protected. More particularly, in order to protect the load 10 against the remaining trouble energy, two fine energy devices in the form of suppressor diodes SD1 and SD2 are provided having first terminals connected with the first L1 and second L2 lines via normally-closed relay-operated switch contacts 3b and 3c, respectively, and second terminals that are joined by a common measuring junction M. This measuring junction M is connected with the third line 13 by a circuit branch including two diodes D1 and D2 of opposite polarity connected in parallel. A biasing potential PE is applied to the third output terminal A3 from the voltage source 12.

The number of branches and fine energy devices described above is not limited to two. This structure is intended merely to serve as an example, and may, depending upon the specific application, be different without departing from the scope of the present invention.

In any case, the protective circuit 1 is installed and connected with the electrical system that is to be protected in such a way that electrical energy that is coupled in during a disruptive event is coupled into the input side of the protective device 1. This is known to a person skilled in the art.

When a disruptive event occurs, electrical energy is coupled into the protective circuit, and as a result of this coupling, currents enter through protective elements FS, SD1, SD2, which can result in the destruction of these protective elements. Destructions of this type especially affect the protective elements SD1 and SD2 embodied here as suppressor diodes.

If an excessively high voltage—i.e., destructive—flows through a suppressor diode SD1, SD2 as a result of a disruptive event, these diodes are destroyed, specifically in such a way that the defective suppressor diode then has a short circuit between its connecting attachments. This response of the suppressor diodes following a disruptive event in which said diodes are destroyed causes a low-resistance connection to be produced between output terminal A1 and the common junction point M, and between output terminal A2 and common junction point M.

This response of suppressor diodes SD1, SD2 in the event of their destruction protects the electrical system, which is connected downstream, from impairment or destruction if further disruptive events should occur, because voltages then occurring at terminal pairs A1-A3 and A2-A3 are limited to a level that poses no risk to the electrical system located downstream. This response is also referred to as “failsave.”

However, in this status, error-free operation of the electrical system that is connected to terminals A1, A2 and A3 is no longer possible, as then measuring and/or energy signals are no longer transmitted in unaffected form by the protective device to the system being protected.

According to the present invention, therefore, protective elements SD1 and SD2 are monitored with respect to previously defined statuses, by means of status detection means 2. For this purpose, the status detection means 2 performs voltage measurements, using measuring means 16 for measuring the voltage at a critical circuit point, labeled M, in the protective circuit 1. The prerequisites for a status of this type can be stored in a storage device 14 of the status detection device 2, thereby to define a reference standard voltage U_{R}. Such prerequisites can involve a specific voltage level, a specific voltage level range, or a specific voltage profile.

Of course, the prerequisites for the stored statuses are selected so as to allow conclusions to be drawn regarding any defects in the relevant protective elements.

When the status detection device 2 recognizes a predetermined status, the corresponding protective elements, in this case SD1 and SD2, are disconnected from the protective circuit at one, multiple, or all poles, of solenoid or relay-operated via break-contact elements, in this case circuit contacts 3a, 3b, which are actuated by the switching relay means R. Consequently, the defective protective elements SD1 and SD2 no longer exert any influence on the protective circuit. Operation of the electrical load system 10 that is being protected can then continue, but at a decreased level of protection provided only by the component FS.

To increase measuring accuracy, the status detection device 2 can be configured in such a way that a protective element SD1, SD2 is deactivated only when, after a certain number of successive measurements determined by the control means 18, the status detection device 2 arrives at the same measurement results/recognized statuses—which point to a defect in protective elements SD1 and/or SD2.

It can further make sen4se to configure the status detection device 2 in such a way that the measurements to be performed for the purpose of status detection are performed at predefined time intervals, for example, every 100 milliseconds, as determined by the control means 20, and/or the measurements are performed at specific, established times.

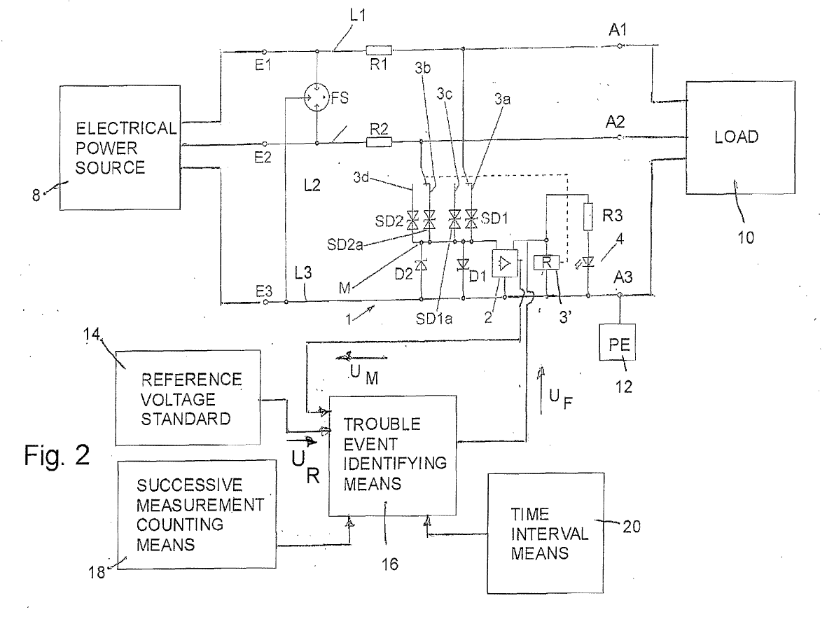

According to a modification of the invention, shown by way of example illustrated in FIG. 2, the protective circuit 1 also has two back-up protective elements, namely, suppressor diodes SD1a and SD2a. The first terminals of these back-up suppressor diodes are connected with lines L1 and L2 by the contacts 3c and 3d, respectively, of a bipolar switch 3′, which contacts are adjacent the contacts 3a and 3b, respectively. Thus, upon the operation of the bipolar relay switch means 2′, the make-contact elements 3c, 3d are actuated by the switching device 3′ following a deactivation of protective elements SD1 and SD2, and which then assume the protective function of the previously deactivated protective elements SD1, SD2.

If the connections or disconnections required to deactivate/activate protective elements are carried out at one, multiple, or all poles, a corresponding switching element, for example, a relay or a bi-polar relay, must naturally have the corresponding number of switching contacts, break-contact elements and/or make-contact elements.

When a predefined status is detected by the status detection means 2, this status can be displayed via a display device 4, for example, a light-emitting diode, with a series resistor, or via a signaling device, for example, a bi-polar relay with a break-contact element connected to it, and/or said status can be retransmitted to additional, optionally higher-level, electrical devices for further processing.

The invention is not limited to the embodiments described, which may be modified in a multitude of ways. In particular, it is possible to configure said features in combinations other than those described here.

It is further conceivable to configure the invention in such a way that back-up protective elements are actuated in cascading fashion. For example, when a first disruptive event has occurred, a first back-up protective element can be activated, when a second disruptive event has occurred, a second back-up protective element can be activated, etc. Of course, before a back-up protective element is activated, the corresponding, potentially defective protective elements must be deactivated, as described in the present disclosure.

It is further conceivable within the scope of the invention to deactivate protective elements other than the protective elements indicated and/or to replace said protective elements with corresponding protective elements that are then to be activated.

While in accordance with the provisions of the Patent Statutes the preferred forms and embodiments of the invention have been illustrated and described, it will be apparent to those skilled in the art that changes may be made without deviating from the invention described above.

What is claimed is:

1. An overvoltage protection circuit (1) for protecting against damage by lightening, voltage surge, or other trouble event a load (10) supplied with electrical power from a source (8), comprising:
(a) an electrical circuit including at least three lines (L1, L2, L3) having input terminals (E1, E2, E3) respectively connected with the voltage source, and output terminals (A1, A2, A3) connected with the load;
(b) coarse protection means (FS) for dissipating the major portion of the energy of the trouble event;
(c) fine protection means for limiting to a safe degree the remaining potion of the energy of the trouble event, said fine protection means including:
(1) a first suppressor diode (SD1) having a first terminal connected with said first line (L1), and
(2) a second suppressor diode (SD2) having a first terminal connected with said second line (L2), said first and second suppressor diodes having second terminals connected with a common measuring junction (M); and
(3) means (D1,D2) connecting said common measuring junction with said third line (L3);
(4) said first and second suppressor diodes each being subject to destruction upon overload above a given voltage value;
(d) status diagnosing means (2) for determining the state of operation of said suppressor diodes, said status diagnosing means including:
(1) means (14) defining a reference voltage standard (U_{R});
(2) trouble event identifying means (16) for comparing with said reference voltage standard the residual voltage (U_{M}) existing at said measuring junction, and for developing a fault signal (U _{F}) when said diagnostic voltage does not meet the standards set by said reference voltage standard; and
(e) disconnect means (3) responsive to said fault signal for disconnecting at least one of said suppressor diodes from said protection circuit.

2. An overvoltage protection circuit as defined in claim 1, and further including means (12) for applying a biasing voltage (PE) to said third output terminal

3. An overvoltage protection circuit as defined in claim 1, wherein said disconnect means is operable to disconnect both of said suppressor diodes, said disconnect means including a disconnect switch (3) having first contacts (3a, 3b) for disconnecting the first terminals of said suppressor diodes from the associated protection circuit lines (L1, L2), respectively.

4. An overvoltage protection circuit as defined in claim 3, wherein said disconnect switch comprises a relay-operated single-pole switch (3).

5. An overvoltage protection circuit as defined in claim 3, wherein said disconnect switch comprises a relay-operated bipolar switch (3′) having second contacts (3c, 3d) spaced from said first contacts, respectively; and further including:
(f) a pair of back-up suppressor diodes (SD1a, SD2a) having first terminals connected with said first and second lines by said bipolar switch second contacts, respectively, and second terminals connected with said measuring junction (M), whereby when said first and second suppressor diodes are disconnected from the protection circuit, said pair of back-up suppressor diodes are connected in the protection circuit.

6. An overvoltage protection circuit as defined in claim 1, wherein said common junction connecting means comprises a branch circuit including a pair of diodes (D1, D2) of opposite polarity connected in parallel.

7. An overvoltage protection circuit as defined in claim 1, and further including display means (4) responsive to said fault signal for indicating the condition of said suppressor diodes.

8. An overvoltage protection circuit as defined in claim 1, and further including means (18) for operating said status diagnosing means at predetermined times.

9. An overvoltage protection circuit as defined in claim 1, and further including means (20) for operating said status diagnosing means at predetermined time intervals.

10. An overvoltage protection circuit as defined in claim 1, and further including means defining a predetermined number of measurement required before the generation of said fault signal.

11. An overvoltage protection circuit as defined in claim 1, wherein said reference voltage standard (U_{R}) comprises a predetermined voltage level.

12. An overvoltage protection circuit as defined in claim 1, wherein said reference voltage standard (U_{R}) comprises a predetermined voltage range.

13. An overvoltage protection circuit as defined in claim 1, wherein said reference voltage standard (U_{R}) comprises a predefined voltage gradient profile.
